(19) United States
(12) Patent Application Publication
(10) Pub. No.: US 2026/0259458 A1
(43) Pub. Date: Sep. 3, 2026

(54) FERROELECTRIC SMECTIC A PHASE MATERIALS, DEVICES INCLUDING THE MATERIALS, AND METHODS OF FORMING AND USING SAME

(71) Applicant: The Regents of the University of Colorado, a Body Corporate, Boulder, CO (US)

(72) Inventors: Joseph E. MACLENNAN, Boulder, CO (US); Noel A. CLARK, Boulder, CO (US); Matthew A. GLASER, Boulder, CO (US); Xi CHEN, Boulder, CO (US); Vikina MARTINEZ, Boulder, CO (US)

(21) Appl. No.: 18/878,251

(22) PCT Filed: Jun. 23, 2023
(86) PCT No.: PCT/US2023/026151

§ 371 Date: Dec. 23, 2024

Related U.S. Application Data
(60) Provisional application No. 63/354,991, filed on Jun. 23, 2022.

(51) Int. Cl. G02F 1/1343

(52) U.S. Cl. CPC G02F 1/1343

(57) ABSTRACT

Devices including a volume comprising ferroelectric smectic A (SmAF) liquid crystal-forming fluid and methods of forming and using such devices are disclosed. Exemplary devices include one or more surfaces and one or more electrodes thereon for application of an electric field to the volume.

### CROSS-REFERENCE TO RELATED APPLICATIONS

This application claims priority to U.S. Provisional Application No. 63/354,991, entitled FERROELECTRIC SMECTIC A PHASE MATERIALS, DEVICES INCLUDING THE MATERIALS, AND METHODS OF FORMING AND USING SAME, filed Jun. 23, 2022, the contents of which are hereby incorporated herein by reference.

### STATEMENT REGARDING FEDERALLY-SPONSORED RESEARCH OR DEVELOPMENT

This invention was made with government support under grant numbers DMR2005170 and DMR1710711 awarded by the National Science Foundation. The government has certain rights in the invention.

### FIELD OF THE DISCLOSURE

The present disclosure generally relates to devices comprising a ferroelectric material liquid crystal material. More particularly, the disclosure relates to devices comprising ferroelectric smectic A liquid crystal forming material.

### BACKGROUND OF THE DISCLOSURE

Ferroelectricily in liquids was predicted in the 1910s by P. Debye and M. Born, who applied the Langevin-Weiss model of ferromagnetism to the orientational ordering of molecular electric dipoles. Recently, interest in nematic ferroelectricity has gained interest. Nematic ferroelectricity presents opportunities for novel liquid crystal science and technology thanks to its unique combination of macroscopic polar ordering and fluidity. Further, a new phase of ferroelectric nematic may provide additional desired features for devices and application. Accordingly, improved devices and methods using ferroelectric nematic material are desired.

Any discussion of problems and solutions set forth in this section has been included in this disclosure solely for the purpose of providing a context for the present disclosure and should not be taken as an admission that any or all of the discussion was known at the time the invention was made.

### SUMMARY OF THE DISCLOSURE

This summary is provided to introduce a selection of concepts. This summary is not intended to necessarily identify key features or essential features of the claimed subject matter, nor is it intended to be used to limit the scope of the claimed subject matter.

Liquid crystal science grows in richness and applicability with each new phase that is found or created. The recent discovery of the ferroelectric nematic was both thrilling and unexpected, since it appeared in new molecules not much different in structure from many similar materials studied over the last 100 years. Clearly, significant, and sometimes seemingly magical, secrets remain to be discovered in the complexities of organic molecular architecture and interaction. A fundamental question following the ferroelectric nematic discovery was whether there could also be a ferroelectric smectic A, the nematic-companion phase obtained when molecules spontaneously slide to form planar, fluid layers normal to their molecular long axes. Here we report such a phase and disclose devices including such phase and methods of using the phase.

Embodiments of the disclosure relate to devices that includes smectic A_{F}, a new liquid crystal phase of the ferroelectric nematic realm. The smectic A_{F} is a phase of small polar, rod-shaped molecules which form two-dimensional fluid layers spaced by approximately the mean molecular length. The phase is uniaxial, with the molecular director, the local average long-axis orientation, normal to the layer planes, and ferroelectric, with a spontaneous electric polarization parallel to the director. As discussed in more detail below, polarization measurements indicate almost complete polar ordering of the ~10 Debye longitudinal molecular dipoles, and hysteretic polarization reversal with a coercive field ~2×10⁵ V/m is observed. The SmA_{F} phase appears upon cooling in two binary mixtures of partially fluorinated mesogens: 2N/DIO, exhibiting a nematic (N)-smectic Z_{A} (SmZ_{A})-ferroelectric nematic (N_{F})—SmA_{F} phase sequence; and 7N/DIO, exhibiting an N—SmZ_{A}-SmA_{F} phase sequence.

Various embodiments of the present disclosure relate to devices comprising ferroelectric smectic A (SmA_{F}) liquid crystal-forming fluid and to methods of using and forming the devices. Examples of the disclosure may be set forth below, including in the claims as originally filed and which are incorporated herein by reference.

In accordance with exemplary embodiments of the disclosure, a device includes a volume comprising ferroelectric smectic A (SmA_{F}) liquid crystal-forming fluid and means for containing said fluid. The fluid includes molecules organized into layers. The molecules have one or more electric dipoles. The molecules have (e.g., spontaneously) formed a ferroelectric polarization density, said polarization density comprising a nonzero local unidirectional average orientation of said dipoles, and said polarization density comprising a magnitude and a vectorial direction in said volume, said vectorial direction being locally normal to said layers. In accordance with examples of the disclosure, the device includes one or more electrodes for application of an electric field to said volume. Electrodes, as described herein, can be formed of any suitable conductive material, such as gold, copper, aluminum, indium tin oxide (ITO), or the like. In some cases, the electromagnetic field can propagate in said volume, said electric field causing said polarization density to change in magnitude, thereby producing a change in the electromagnetic field. In some cases, said electric field can cause said polarization density to change the vectorial direction, thereby producing a change in the electromagnetic field. In some cases, said electric field can cause said polarization density to change in the vectorial direction and/or the magnitude, thereby producing a physical motion of or change of shape of said volume. In accordance with further examples, the device can include one or more electrodes for measuring the electric potential or current flow within said volume, said electric potential and/or current flow generated by change in said polarization density, said change due to a variation in stress within said volume or change of shape of at least a portion of said volume. In some cases, the device can thermally generate a charge density, wherein said device includes one or more electrodes for measuring an electric potential or obtain a current flow within said volume, said electric potential and/or current flow generated by a change in said polarization density, said change of said polarization density produced by a change in temperature of said volume. The volume can be contained between parallel surfaces. The electric field can be applied parallel to the surfaces. The polarization density and/or electromagnetic field can be parallel to said surfaces. In accordance with various examples of the disclosure, the volume includes two or more distinct molecules. In accordance with these and other embodiments, the molecules comprise features suitable for the stabilization of a ferroelectric smectic A phase comprising one or more of: (1) a rod shape having a molecular long axis suitable for smectic A liquid crystal ordering; (2) a substantial molecular net dipole parallel to the molecular long-axis, said dipole stabilizing head-to-tail chaining of said rod-shaped molecules; (3) molecular subcomponents along the molecular length giving localized charges of alternating sign distributed along said molecular long axis; (4) minimal flexible tails to enable dipolar charges to interact, but provide enough flexibility to suppress crystallization; and (5) lateral groups to control the relative positions along the director of side-by-side molecules, to promote their polar order.

In accordance with further examples of the disclosure, a device includes a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the electric polarization density throughout the volume; and one or more materials comprising one or more surfaces in contact with the volume, wherein said one or more surfaces are configured to impart a favored surface polarity of the molecules, said favored surface polarity controlling said vectorial orientation at the interfaces with the one or more surfaces. The one or more materials can include a first material comprising a first surface in contact with the volume and a second material comprising a second surface in contact with the volume. The favored surface polarity of the molecules can include, for example, a component locally normal to and directed away from at least one of the one or more surfaces, toward at least one of the one or more surfaces, or a component locally tangent to at least one of the one or more surfaces. The favored surface polarity of the molecules can include a component created via photo-degradation induced by illumination of one or more of the surfaces, deposition of material onto a surface of the one or more surfaces, deposition of material onto a surface of the one or more surfaces, where said deposition is oblique, etching of material from the one or more materials, or the like. Exemplary devices can further include one or more electrical connections to apply an electric field to the volume and/or an apparatus to apply an electromagnetic field to the volume. The device can further comprise dopant molecules dissolved in the SmA_{F} phase. The dopant molecules can have dipole moments, said dipole moments being preferentially aligned by the vectorial orientation field of the SmA_{F} phase adjacent to or in the vicinity of said dopant molecules. In accordance with examples, the SmA_{F} phase is a mixture of two or more distinct molecular species; the SmA_{F} phase can be a eutectic mixture.

In accordance with yet further examples of the disclosure, a method for controlling a favored vectorial orientation in three dimensions of a polarization field of a SmA_{F} liquid crystal at an interfacial surface with a material or materials is provided. The method includes providing a volume comprising SmA_{F} liquid crystal-forming molecules, providing a first material having a first surface in contact with the volume, and using the first surface, imparting a favored surface polarity of the molecules, said favored surface polarity controlling said favored vectorial orientation of the molecules in said volume. The method can further include providing a second material having a second surface in contact with the volume. The favored surface polarity of the molecules can include a component locally normal to the surface and directed toward the surface, a component locally normal to the surface and directed away from the surface, or a component locally tangent to the first surface (e.g., a unique favored azimuthal orientation about the surface normal). Exemplary methods can further include a step of applying an electric field to said SmA_{F} phase. Dopant molecules can be dissolved in the SmA_{F} phase, as described above and elsewhere herein. In accordance with examples, the SmA_{F} phase is a mixture of two or more distinct molecular species; the SmA_{F} phase can be a eutectic mixture.

In accordance with yet further examples, a device includes a volume comprising SmA_{F} liquid crystal-forming molecules and a first material comprising a first surface in contact with the volume, wherein the first surface is configured to impart a favored surface polarity of the molecules to control a vectorial orientation of the molecules within the volume at an interface with the first surface. The volume can include a SmA_{F} phase.

In accordance with yet further examples of the disclosure, a material comprising a ferroelectric smectic A (SmA_{F}) material comprises two or more molecular components. The material can include a mixture of first molecules and second molecules.

In accordance with yet further examples, a method of forming a material having a tunable SmA_{F} phase comprises mixing of multiple molecules to form a mixture having a SmA_{F} phase, wherein certain of the molecules induce a polar orientational order of one or more of the other molecules.

In accordance with yet additional examples, a device includes a volume containing a ferroelectric smectic A (SmA_{F}) liquid crystalline material, a dielectric layer overlying a portion of the volume, and a charge-bearing substrate overlying at least a portion of the dielectric layer, wherein the volume comprises a polarization charge proximate the dielectric layer that is controllable by a charge on and/or applied to the charge-bearing substrate. The device can include one or more additional dielectric layers overlying the volume. In such cases, the device can include one or more additional charge-bearing substrates overlying the one or more additional dielectric layers. In some cases, each surface bounding said SmA_{F} liquid crystal comprises a dielectric layer adjacent to the liquid crystal and a proximate charge-bearing substrate, each surface having finite capacitance and hence acting as a capacitor. In accordance with aspects of these embodiments, the polarization charge and molecular orientation of the SmA_{F} liquid crystal on the inner (liquid crystal) side of the capacitor is controlled by varying the charge on the outer (substrate) side of the capacitor. In accordance with further aspects, the charge on the bounding surface and the resulting molecular orientation of the SmA_{F} liquid crystal responds to external fields or other stimuli, including external electromagnetic or optical fields, chemical or electrochemical reactions, biomolecular binding events, mechanical strain or shear, and fluid flow. A response to external fields or other stimuli is detected electrically and/or optically. A sensor, actuator, and/or energy conversion device can include a device as described in this paragraph and elsewhere herein. In some cases, the volume comprising a SmA_{F} liquid crystal is at least partially bounded by surfaces with spatially varying capacitance, in which said molecular orientation in said SmA_{F} material exhibits spatially varying analog response to applied voltages. In accordance with further examples, the volume comprising a SmA_{F} liquid crystal is at least partially bounded by surfaces with spatially varying capacitance and with patterned electrodes on the bounding substrates, in which said molecular orientation in said ferroelectric nematic material exhibits spatially varying analog response to voltages applied to said patterned electrodes.

In accordance with yet further examples of the disclosure, a composite material includes a first porous material, the volume of said pores of said material containing ferroelectric smectic A (SmA_{F}) liquid crystal. The volume of said pores of said porous material can be substantially filled with SmA_{F} liquid crystal. A semiconducting structure can include a porous, solid material, the volume of said pores of said material containing SmA_{F} liquid crystal. A dielectric structure can include a porous, solid, electrically insulating material, the volume of said pores of said material containing SmA_{F} liquid crystal. A capacitor can include electrodes and a dielectric medium, said dielectric medium comprising a porous, solid, electrically insulating material, the volume of said pores of said material containing SmA_{F} liquid crystal. A porosity of porous material 104 can range from about 0.05 to about 0.4 or about 0.5 to about 0.95. A pore size or an average pore size of pores of porous material 104 can range from about 2 nm to about 50 nm or about 0.1 micrometer to about 10 micrometer. In accordance with further examples, a dielectric medium comprises a SmA_{F} liquid crystal and a solid material, said solid material dispersed in the liquid crystal as particulates. A dielectric constant of the dielectric medium can be greater than 10 or between about 2 and about 5000.

In accordance with further examples, a dielectric medium comprises a SmA_{F} liquid crystal and a solid material, said solid material comprised of ferroelectric or superparaelectric nanoparticles.

In accordance with yet further examples, a dielectric medium comprises a dispersion of a SmA_{F} liquid crystal and a solid material, said dispersion formed by phase separation.

In accordance with further examples, a dielectric medium comprises a dispersion of a SmA_{F} liquid crystal and a solid material, said dispersion formed by photo-polymerization.

In accordance with further examples, a dielectric medium comprises a dispersion of a SmA_{F} liquid crystal and a solid material, said dispersion stabilized by amphiphilic molecular components.

In accordance with further examples, a dielectric medium comprises an emulsion of a SmA_{F} liquid crystal and a fluid material, said emulsion stabilized by amphiphilic molecular components. Exemplary suitable fluid materials include ionic liquids, dielectric liquids, and conductive liquids.

A device can include a composite material or dielectric medium as described herein. The device can include, for example, an energy storage device (e.g., an energy conversion device), an information storage and processing device, an actuator, sensor, electrocaloric device, or a device for electric to mechanical energy conversion through electromechanical effects, or the like.

In accordance with further examples of the disclosure, a device includes a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the dipolar SmA_{F} liquid crystal-forming molecules throughout the volume, said dipolar molecules possessing a finite first hyperpolarizability β; and one or more electrical connections to apply an electric field to the SmA_{F} liquid crystal-forming molecules.

In accordance with yet additional examples, a device includes a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the dipolar SmA_{F} liquid crystal-forming molecules throughout the volume, said dipolar molecules possessing a finite first hyperpolarizability β, and one or more materials comprising one or more surfaces in contact with the volume, wherein said one or more surfaces are configured to impart a favored surface polarity of the SmA_{F} liquid crystal-forming molecules, said favored surface polarity controlling said vectorial orientation at the interfaces with the one or more surfaces.

In accordance with yet additional examples, a volume comprises ferroelectric smectic A (SmA_{F}) liquid crystal-forming molecules, said volume containing a SmA_{F} liquid crystal phase, said SmA_{F} liquid crystal phase comprising a vectorial orientation field of the dipolar SmA_{F} liquid crystal-forming molecules throughout the volume, said dipolar molecules possessing a finite first hyperpolarizability β; one or more electrical connections to apply an electric field to the SmA_{F} liquid crystal-forming molecules; and one or more materials comprising one or more surfaces in contact with the volume, wherein said one or more surfaces are configured to impart a favored surface polarity of the SmA_{F} liquid crystal-forming molecules, said favored surface polarity controlling said vectorial orientation at the interfaces with the one or more surfaces.

Various devices described herein can be used for, for example, electronic electro-optic phase, amplitude, or polarization modulation of electromagnetic fields, nonlinear optical frequency mixing of electromagnetic fields, including second harmonic generation and sum and difference frequency generation, nonlinear optical terahertz (THz) electromagnetic field generation and/or sensing, nonlinear optical frequency conversion, as a component of a photonic integrated circuit, or the like.

In accordance with yet additional examples, materials can comprise fibers of SmA_{F} liquid crystal and/or thin films of SmA_{F} liquid crystal. Such materials can be incorporated into composite materials comprising polymeric, amphiphilic, and/or solid components.

Such materials can be functional textiles or fabrics. An electro-optic device can be formed using such materials. Exemplary fibers can have a length of about 20 μm to about 100 μm or about 1 mm to about 20 mm and/or a cross-sectional dimension (e.g., diameter) of about 5 μm to about 40 μm or about 100 μm to about 300 μm.

In accordance with yet further examples, materials comprising a SmA_{F} liquid crystal comprise dipolar molecules with large first hyperpolarizability β, wherein said dipolar molecules have polar orientational order, said polar orientational order controlling the second-order nonlinear optical properties of said materials.

These and other embodiments will become readily apparent to those skilled in the art from the following detailed description of certain embodiments having reference to the figures; the disclosure not being limited to any particular embodiment(s) disclosed.

### BRIEF DESCRIPTION OF DRAWINGS

A more complete understanding of the embodiments of the present disclosure may be derived by referring to the detailed description and claims when considered in connection with the following illustrative figures.

FIG. 1 illustrates structures, phase sequences and schematics of the liquid crystal phase behavior of 2N, 7N, and DIO single components, and their indicated mixtures.

FIG. 2 illustrates X-ray scattering and polarized microscopy textures of the N_{F} and SmA_{F} phases in the 50:50% 2N/DIO mixture.

FIG. 3 illustrates X-ray scattering and polarized microscopy textures of the N_{F} and SmA_{F} phases in the 50:50% 7N/DIO mixture.

FIG. 4 illustrates X-ray diffraction from the periodic density modulation of the SmZ_{A} phase in the 7N/DIO mixtures.

FIG. 5 illustrates response of SmA_{F} texture to field and frustration in the cell of FIG. 2 C,D (d=3.5 μm spacing cell with anti-parallel surface rubbing), in SmA_{F} domains (broad vertical bands) that have replaced a n-twisted N_{F} phase (needle-like vertical domains in A-C, bright blocks in D, and triangular regions in F).

FIG. 6 illustrates I(t)-V(t) characteristics of the 2N/DIO mixture as a function of temperature with a 30 V peak amplitude, 8 Hz triangle-wave voltage (white, triangular trace) applied to a d=17 μm ITO-sandwich cell with bookshelf layering in the smectic phases and polarization values P(T) [open circles] were obtained by integrating the current.

FIG. 7 illustrates a device in accordance with various examples of the disclosure.

FIG. 8 illustrates another device in accordance with various embodiments and examples of the disclosure.

FIG. 9 illustrates cell deformation modes for electro-mechanical energy conversion.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

Although certain embodiments and examples are disclosed below, it will be understood that the invention extends beyond the specifically disclosed embodiments and/or uses thereof and obvious modifications and equivalents thereof. Thus, it is intended that the scope of the invention disclosed should not be limited by the particular disclosed embodiments described below.

The present disclosure generally relates to devices comprising ferroelectric smectic A (SmA_{F}) liquid crystal-forming fluid and to methods of forming and using the devices.

In this disclosure, any two numbers of a variable can constitute a workable range of the variable, and any ranges indicated may include or exclude the endpoints. Additionally, any values of variables indicated (regardless of whether they are indicated with “about” or not) may refer to precise values or approximate values and include equivalents, and may refer to average, median, representative, majority, etc. in some embodiments. Any value, such as a percent, can include +/−10 percent or +/−5 percent or +/−2 percent of that value. A direction (such as normal or tangent), can include, for example, +/−10 degrees or +/−5 degrees or +/−2 degrees from such a direction. Further, in this disclosure, the terms “including,” “constituted by” and “having” and related words can refer independently to “typically or broadly comprising,” “comprising,” “consisting essentially of,” or “consisting of” in some embodiments. In accordance with aspects of the disclosure, any defined meanings of terms do not necessarily exclude ordinary and customary meanings of the terms.

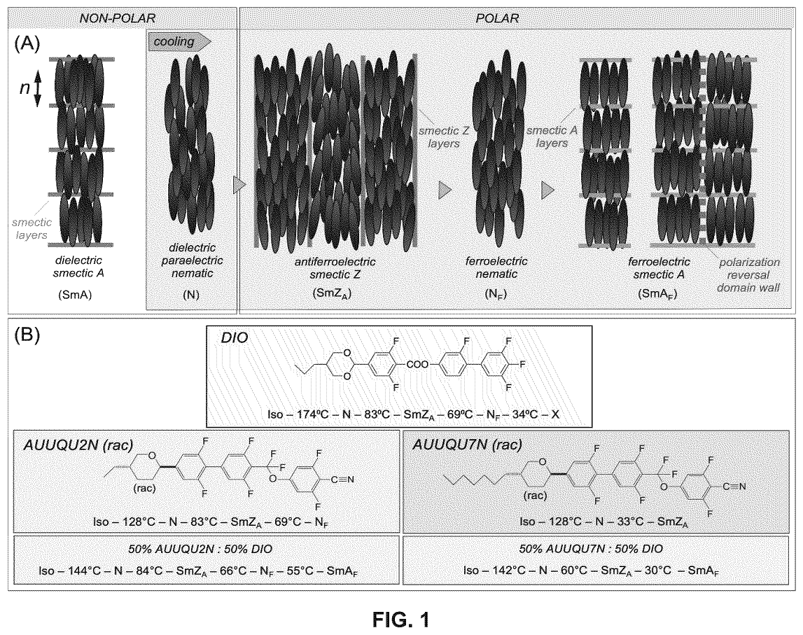

Turning now to the figures, FIG. 1 illustrates structures, phase sequences and schematics of the liquid crystal phase behavior of 2N, 7N, and DIO single components, and their indicated mixtures. As described in more detail below, relevant phases of rod-shaped molecules with on-axis electrical dipole moments are shown, where the dipole direction of a schematic molecule is indicated by its vertical shading. (A) Sketches of the phase organization, grouped into macroscopically non-polar and polar types. The experiments reported below confirm the existence of the previously described paraelectric nematic (N), antiferroelectric smectic Z (SmZ_{A}), and ferroelectric nematic (N_{F}) phases, as well as the new SmA_{F} phase. These phases appear upon cooling with the general order vs. T shown in the—shaded area. Note that the N_{F} phase is missing in the 7N/DIO mixture, allowing for a direct smectic Z to smectic A_{F} transition. The solid, heavy lines depict smectic layering. The SmA_{F} phase is spontaneously ferroelectric, with polarization β ~6 μC/cm² and polar order parameter p~0.9, values comparable to those of the N_{F} phase of DIO and RM734. Polarization reversal is effected by the motion of pure polarization reversal domain walls. The antiferroelectric layer-by-layer alternation of polarization induces director splay modulation in the SmZ_{A} phase, but splay is suppressed in the ferroelectric N_{F} and SmA_{F} phases.

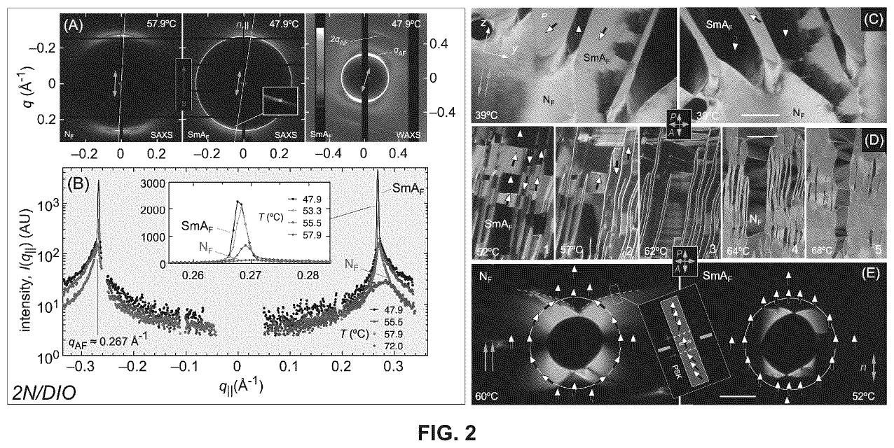

FIG. 2 illustrates X-ray scattering and polarized microscopy textures of the N_{F} and SmA_{F} phases in the 50:50% 2N/DIO mixture. (A) Typical non-resonant SAXS and WAXS obtained on cooling from N_{F} to SmA_{F}. In the N_{F} phase at 57.9° C., there are nematic-like diffuse scattering arcs, peaked along n at q_{z}~0.27 Å⁻¹, coming from head-to-tail correlation of the mixture molecules. (B) Radial intensity scans along the n,q_{z} direction (the white lines in (A)) at different temperatures. In this illustrated case, the scattering pattern rotates azimuthally by as much as 10° due to textural reorganization within the capillary as the smectic layers form. The initially diffuse smectic peak sharpens somewhat on cooling, until a distinct, resolution-limited SmA_{F} Bragg reflection appears in the n direction at T≈56° C., as shown in the inset, indicative of smectic ordering with the layer planes normal to n. The scattering vector q_{zAF}≈0.267 Å⁻¹ corresponds to a SmA_{F} layer spacing of 23.5 Å, close to the wt % average molecular length of DIO (23.2 Å) and 2N (23.4 Å). The SmA_{F} peak position is very close to that of the nematic peak, as expected for an orthogonal smectic phase. The polarized light microscope images show the 50:50 wt % 2N/DIO mixture in (C,D) a d=3.5 μm thick, antipolar cell (with anti-parallel surface rubbing) and (E) a d=3.5 μm thick, synpolar cell (with parallel surface rubbing), both in the absence of applied field. (C) The SmA_{F} phase grows in, upon slow cooling, from the top of this region of the cell at T≈55° C., irregular polygon-shaped domains of layers n and P oriented parallel to the cell plates and uniformly aligned throughout their volume. The existing N_{F} is in a surface-induced, n-twisted state, with P along the (antiparallel) buffing at the surfaces. This twisted state imposes no preferred bulk polarization orientation. As a result, the advancing SmA_{F} domains are ambivalent in their choice of polarization alignment and appear with P aligned locally either along +z or along −z, as shown. (D) A different part of the cell observed on heating from the SmA_{F} to the N_{F} phase. In their steady state, shown in D1, the SmA_{F} domains are generally extended along z to minimize polarization space-charge, with the domains separated by melted grain boundaries and polarization-stabilized kinks (PSKs), sketched in the inset in (E), which mediate small changes in the orientation of P along z. In contrast, non-zero (∂P_{z}/∂y) does not generate polarization charge, enabling neighboring domains with P directions that alternate in sign with changing y. Upon heating to the N_{F}, the boundaries between these adjacent domains transform into splay-bend walls (bright lines in D2,3), which then broaden into n-twist domains that eventually cover most of the cell (D4,5). (E) In the synpolar cell, a uniform monodomain is formed on cooling, with n in both the N_{F} and SmA_{F} phases generally along the buffing direction, giving excellent extinction, and P along the polar orientation preferred in the N_{F} phase. The images show the texture around an air bubble extending through the thickness of the cell. The preferred orientation of P on the bubble boundary is tangential. At the bubble meridian, this boundary condition is compatible with the uniform polarization preferred by the cell surfaces but elsewhere, n,P twists in the interior of the cell to accommodate this boundary condition, and the cell has a non-extinguishing, yellow-green transmission color. This non-uniform state persists up to the curved, dashed lines above the bubble, where the director field reverts to the preferred uniform state. These lines of polarization-stabilized kinks, globally parabolic in shape, having a local structure (shown in the inset) that minimizes polarization charge while mediating a change of orientation of P. Once the SmA_{F} grows in, the expulsion of layer twist and bend forces more of the area surrounding the bubble into a uniform state, with the non-uniform region confined to a small area near the bubble. The residual transmission in the regions bordering the air bubble is presumably due to dislocations in the SmA_{F} layering. Scale bars: (C) 500 μm; (D) 200 μm; (E) 100 μm.

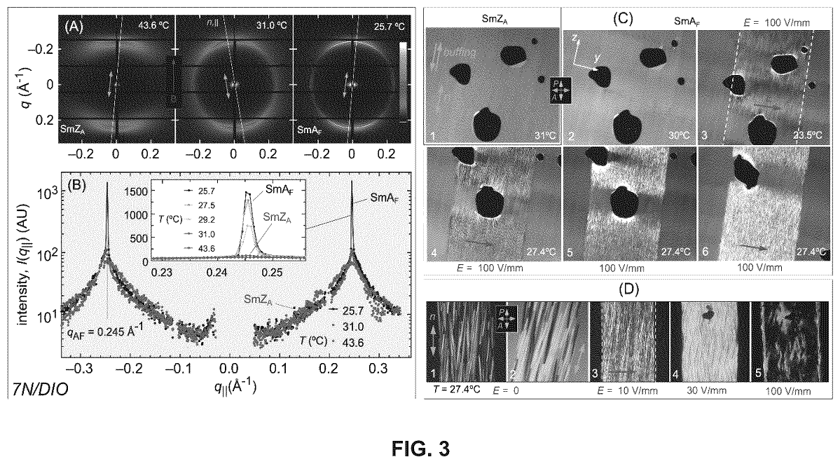

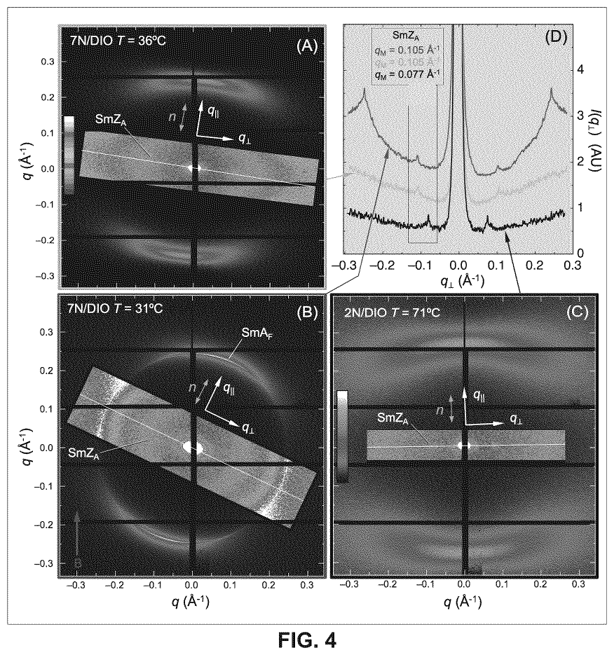

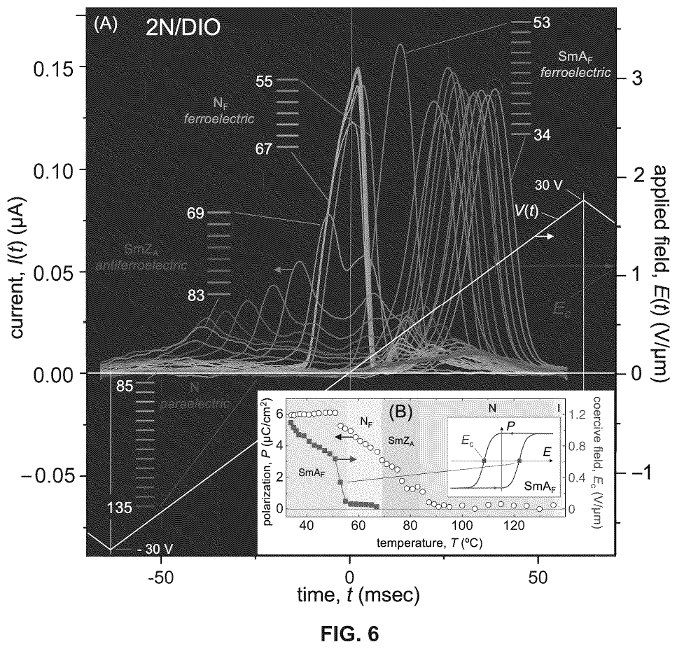

FIG. 3 illustrates X-ray scattering and polarized microscopy textures of the N_{F} and SmA_{F} phases in the 50:50% 7N/DIO mixture. (A) Typical non-resonant SAXS obtained on cooling from SmZ_{A} to SmA_{F}. In the SmZ_{A} phase at 43.6° C., the SAXS shows a diffuse scattering arc, peaked along n at q_{z}~0.27 Å⁻¹, from head-to-tail correlation of the mixture molecules, features also observed in the diffraction patterns of DIO. (B) Radial intensity scans along the n,q_{z} direction (the white lines in (A)) at different temperatures. As in the 2N mixture, the scattering pattern rotates and spreads due to textural reorganization within the capillary as the SmZ_{A} layers are replaced by SmA_{F} layers. The scattering from the SmZ_{A} layering is not visible here but is shown in FIG. 4. Upon cooling, the diffuse peaks sharpen somewhat, the SmZ_{A} layering peaks along q, weaken and disappear, and at T≈31° C., distinct, resolution-limited Bragg reflections appear along q_{z} as shown in the inset, indicative of smectic ordering with the layer planes normal to n. The scattering wavevector, q_{zAF}~0.245 Å⁻¹, corresponds to a SmA_{F} layer spacing of 25.6 Å, close to the wt % average molecular length of DIO (23.2 Å) and 7N (29.1 Å). The position of the SmA_{F} scattering peak is very close to that of the diffuse nematic peak, as expected for an orthogonal smectic phase. (C,D) Polarized microscopy images of an antipolar cell with a d=3.5 μm spacing and electrodes spaced by 1 mm (dashed white lines) for applying an in-plane field normal to the buffing direction, z. The planar-aligned SmZ_{A} texture shows only subtle changes upon transitioning to the SmA_{F} (C1,2). This is because the antiparallel buffing, while it orients the director, does not favor either of the antiferroelectric polarization directions, so that at the transition the nanoscale antiferroelectric SmZ_{A} layers normal to y simply coarsen into SmA_{F} domains extended in z, along the new layer normal, and alternating in polarization along y. The director remains uniform through this change, giving a very similar appearance to the two phases. However, applying a small E-field applied along y (C3-6), causes the director in stripes of opposite P to rotate away from extinction in opposite directions, generating optical contrast that confirms their opposite polarity. The circular black regions are air bubbles, which effectively screen the applied electric field in the adjacent liquid crystal, leaving the original texture undisturbed. (D) Annealing after such field treatment yields an inhomogeneous smectic fan texture (D1,2). In an applied field, these domains reorient, buckle, and, in sufficiently large applied field, coarsen to form large domains with the n, z, and P all oriented along the field, normal to the buffing direction (D3 to 5). Thus, it appears that, during field-induced reorientation, n, z, and P remain coupled together, with the threshold originating from the elasticity and plasticity of the smectic layering. This threshold also results in the appearance of a coercive field in the polarization hysteresis (FIG. 6). The N_{F} phase is readily reoriented by the weak stray applied fields over the electrodes. In the SmA_{F} phase, however, there is a field threshold for such reorientation, so field effects are confined to the electrode gaps. Scale: the electrode gap (dashed white lines in C) is 1 mm wide.

FIG. 4 illustrates X-ray diffraction from the periodic density modulation of the SmZ_{A} phase in the 7N/DIO and 2N/DIO mixtures. Panels (A) to (C) each show a complete SAXS image of the scattered intensity, I(q), using the color gamut shown in (C). The rectangular overlays show I(q) after histogram stretching and using the color gamut in (B), revealing the weak scattering peaks from the SmZ_{A} layer modulation along q_{y}. The director is aligned in the nematic phase by a magnetic field, B, but rearrangements of the sample in the capillary during cooling lead to some inhomogeneity of the SmZ_{A} and SmA_{F} layer orientation. (A) At T=36° C., the 7N/DIO mixture is in the SmZ_{A} phase, as evidenced by the scattering along q_{y}. The diffuse peaks along q_{z}, parallel to the director, come from short-ranged, end-to-end molecular correlations. The SmZ_{A} peak locations, at |q_{y}|=q_{M}≈0.105 Å⁻¹, corresponds to a layer spacing of d_{M}≈60 Å, essentially independent of T. (B) Cooling to T=31° C. initiates a weakly first-order phase transition to the SmAF, with sharp scattering simultaneously from both the SmZ_{A} and SmA_{F} layers, indicating SmZ_{A}/SmA_{F} phase coexistence. The SmZ_{A} peaks at this temperature appear as extended arcs. The SmZ_{A} scattering disappears 0.5° C. below the onset of the SmZ_{A}−SmA_{F} transition, i.e., there is a narrow range of T where both the SmZ_{A} and SmA_{F} peaks are present, which we attribute to two phase coexistence at a first order transition. (C) Diffraction from the 2N/DIO mixture at T=71° C., in the middle of the SmZ_{A} phase region. (D) Radial scans of the scattered intensity along q_{y}, normal to the director, obtained by averaging I(q) over the range of q_{z} about q_{z}=0 (white lines in C,D) that includes the SmZ_{A} peaks (δq₂±0.015 Å⁻¹). The low-temperature scan of (B) exhibits the SmZ_{A} peaks at q_{y}~0.105 Å⁻¹, as well as SmA_{F} scattering at q_{y}=0.245 Å⁻¹. While dwarfing the SmZ_{A} peaks, this intensity is orders of magnitude smaller than the peak SmA_{F} scattering along q_{z}.

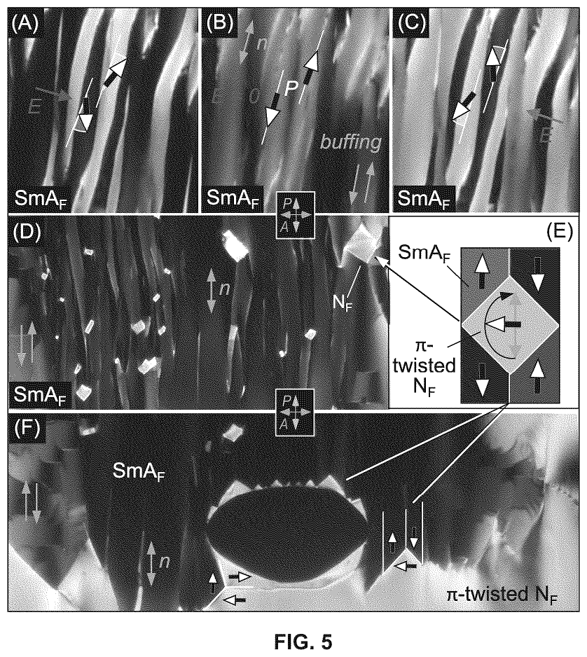

FIG. 5 illustrates a response of SmA_{F} texture to field and frustration in the cell of FIG. 2 C,D (d=3.5 μm spacing cell with anti-parallel surface rubbing), in SmA_{F} domains (broad vertical bands) that have replaced a n-twisted N_{F} phase (needle-like vertical domains in A-C, bright blocks in D, and triangular regions in F). The twisted N_{F} does not bias the polarization preference so domains of both either of P should spontaneously appear. (A-C) This can be tested by applying a transverse in-plane electric field E (substantially normal to n and P) to an area having domains with a generally oriented director. The opposite induced rotation in (A) and (C) confirm the macroscopic uniform polarization within a domain. (D,E) Diamond-shaped inclusions of twisted N_{F} mediate the reversal (D) or termination (E) of up-down pairs of SmA_{F} domains. The white domain boundaries in E are polarization stabilized kinks (PSKs), localized reorientations of P stabilized by the attraction of sheets of polarization charge of opposite sign, as shown in FIG. 2 (E).

FIG. 6 illustrates (A) I(t)-V(t) characteristics of the 2N/DIO mixture as a function of temperature with a 30 V peak amplitude, 8 Hz triangle-wave voltage (while triangular trace) applied to a d=17 μm ITO-sandwich cell with bookshelf layering in the smectic phases. The plot shows the current response during an N→SmZ_{A}→N_{F}→SmA_{F} cooling scan. In the N phase (T>84° C.), the current shows only an ion peak following the sign change of V(t). In the SmZ_{A} phase (84° C.>T>68° C.), two polarization peaks are seen during this half-cycle of the applied voltage, growing in area and occurring at smaller voltage on cooling. This is typical antiferroelectric behavior, the peaks marking the transition at finite voltage between the field-induced ferroelectric states and the equilibrium antiferroelectric state. In the N_{F} phase, the Goldstone-mode mediated reorientation appears “thresholdless” and reversal of P produces a current peak at the zero-crossing of V(t), followed by an ion peak for t>0. The measured polarization in this phase is comparable to that of neat DIO. In the SmA_{F} phase, the ion current disappears and polarization reversal peak occurs at positive voltage corresponding to the coercive field E_{c}, shown, by way of example, for T=34° C. (vertical arrow starting at the right-hand peak of the 34° C. trace leading to horizontal arrow terminating on the right at the applied field axis). The temperature sequence of the I(t) curves is 135, 130, 125, 120, 115, 110, 105, 100, 95, 93, 91, 89, 87, 85, 83, 81, 79, 77, 75, 73, 71, 69, 67, 65, 63, 61, 59, 57, 55, 53, 51, 49, 47, 45, 43, 41, 39, 38, 37, 35, and 34° C. (B) Polarization values P(T) [open circles] were obtained by integrating the current. In the SmZ_{A} phase, the polarization current generated following each zero-crossing of V(t) overlaps with the ion current, so P(T) is obtained in this case by doubling the area of the current peak generated before the zero-crossing. The coercive field, E_{c}, is also shown as a function of T [solid symbols]. Note that in the N_{F} and SmA_{F}, the ion peak is not observed because generally the electric field is very small in the ferroelectric phases because of screening by the polarization charge.

Proper ferroelectricity in liquids was predicted in the 1910's by P. Debye and M. Born, who applied the Langevin-Weiss model of ferromagnetism to propose a liquid-state phase change in which the ordering transition is a spontaneous polar orientation of molecular electric dipoles. A century later, in 2017, two groups independently reported, in addition to the typical nematic (N) phase, novel nematic phases in strongly dipolar mesogens, the “splay nematic” in the molecule RM734 and a “ferroelectric-like nematic” phase in the molecule DIO, illustrated in FIG. 1(B). These nematic phases were subsequently demonstrated to be ferroelectric in both RM734 and in DIO, and to be the same phase in these two materials. This new phase, the ferroelectric nematic (N_{F}), is a uniaxially symmetric, spatially homogeneous, nematic liquid having >90% polar ordering of ius longitudinal molecular dipoles. A related new phase recently observed is the helical ferroelectric N_{F} obtained by chiral doping of RM734, DIO, or their homologs, or by introducing chiral tails into the molecular structures. DIO also exhibits an additional phase, found between the N and N_{F}, which we have recently characterized, terming it the smectic ZA, and showing it also to be new: a density-modulated antiferroelectric exhibiting lamellar order with ~18 nm repeats, comprising pairs of ~9 nm-thick layers with alternating polarization, the director and polarization being oriented parallel to the layer planes. It should be noted that although specific molecules are noted herein, unless otherwise noted, the invention is not limited to such examples.

Here we introduce another new phase of the ferroelectric nematic realm, the smectic A_{F}, a uniaxial, lamellar phase with the director normal to the layers and a spontaneous polarization along the director. Schematic drawings of the phases discussed here, sorted into macroscopically non-polar and polar types, are shown in FIG. 1, along with the molecular structures and phase sequences of the mesogens used in the mixtures. The macroscopically non-polar, paraelectric nematic (N) and smectic A (SmA) phases, the ferroelectric nematic (N_{F}) and ferroelectric smectic A (SmA_{F}) phases, and the antiferroelectric SmZ_{A} phase are sketched in FIG. 1 (A), the light-to-dark shading of the schematic molecules indicating their dipolar symmetry. The SmAF phase is observed in 50:50 wt % AUUQU2N/DIO (2N/DIO) and AUUQU7N/DIO (7N/DIO) mixtures; other weight ratios may also be suitable. The shaded region of FIG. 1 (A) shows the generic phase sequence observed in the mixtures on cooling (iso→N→SmZ_{A}→N_{F}→SmA_{F}→X), noting that some phases may be missing in a given component or mixture. For example, none of the single components exhibits the SmAF phase, and the 7N/DIO mixture does not have the N_{F} phase. The first mesophase that appears on cooling any of the components and mixtures from the isotropic is the conventional dielectric nematic (N) phase, which, in the present context, is also considered paraelectric. They all cool from the N into the antiferroelectric smectic Z (SmZ_{A}) phase.

The 2N/DIO mixture then transitions first to the N_{F} phase and then, on further cooling, to the SmAF, while 7N/DIO goes directly to the SmA_{F}. This enables a comparative study of both the N_{F}→SmA_{F} and SmZ_{A}→SmA_{F} transitions, the latter featuring the simultaneous disappearance of the SmZ_{A} layering parallel to the director and the formation of the SmA_{F} layering normal to the director, in the absence of any director/polarization reorientation.

In contrast to the conventional dielectric smectic A phase, the ferroelectric smectic A phase exhibits a macroscopic polarization P, with the polarization in every layer pointing in the same direction, along the director, n, normal to the layer planes. The phase is uniaxial and has a high degree of polar order (polar order parameter p>0.9). Domains of opposite polarization separated by polarization-reversal walls (sketched in FIG. 1 (A)) are observed in regions with continuous smectic layering.

This ferroelectric phase is distinct from the phases previously described in several families of uniaxial “polar smectics,” including the monolayer paraelectric SmA₁, the partial bilayer SmA_{d}, the antipolar bilayer SmA₂ phase, and a variety of polarization-modulated phases (Sm, Sm, etc.) of dipolar molecules, in that these all have zero net average polarization. Tournilhac and co-workers claimed initially to have observed macroscopic polarization normal to the layers in a small-molecule, smectic A phase, based on evidence of piezoelectricity and non-linear dielectric behavior, but their subsequent x-ray scattering study revealed a smectic unit cell-doubling, leading to the conclusion that the phase in question was a bilayer smectic of the SmA_{d} variety, and that the observed electrical effects were manifestations of bilayer antiferroelectricity. The SmA_{F} is also different from the orthogonal polar smectic phases exhibited by some bent-core mesogens, which form biaxial smectics with the spontaneous polarization oriented parallel to the smectic layers.

### EXEMPLARY EMBODIMENTS

X-ray scattering—We have previously carried out X-ray diffraction, polarized light microscopy, and polarization measurement studies of the single molecular components, DIO and 2N,7N shown in FIG. 1(B). Here we focus on the binary mixtures 2N/DIO and 7N/DIO. All of our observations indicate that the N, NF SmZ_{A}, and SmA_{F} phases observed in these different single components and/or in the mixtures exhibit common experimental characteristics and appear, respectively, to be the same phases in the different materials: the N phases are homogeneous, uniaxial nematics, the NF phases are homogeneous, uniaxial nematics with a macroscopic polarization along the nematic director, and the SmZ_{A} is the same bilayer antiferroelectric phase in all of the components and mixtures, with a layer spacing d_{M}≈90 Å in DIO, d_{M}~81 Å in the 2N/DIO mixture, and d_{M} 160 Å in the 7N/DIO mixture. The period of the layer-by layer antiferroelectric polarization alternation is 2d_{M}.

Here we describe the LC behavior of 50:50% 2N/DIO and 7N/DIO mixtures, both of which exhibit the SmA_{F}. We find that these mixtures show: (i) similar SAXS from the SmA_{F} layering, with smectic layer spacing close to the mean molecular length; (ii) similar uniaxial birefringence; (iii) similar SmA-like optical textures; (iv) similar response of the SmA_{F} to surface alignment conditions and applied electric field; and (v) similar SmZ_{A} and SmA_{F} polarization reversal dynamics. We describe the two mixtures separately because of the differences in how the SmA_{F} grows in on cooling, 2N/DIO coming from the NF phase and 7N/DIO coming from the SmZ_{A} phase, as this condition strongly affects the textural morphology of the SmA_{F}.

For the SAXS and WAXS experiments, the mixtures were filled into 1 mm diameter, thin-wall capillaries and the director n (double-headed arrow in FIG. 2(A)) was aligned by an external magnetic field B (arrow). The SAXS and WAXS was nonresonant, with diffraction images of the samples obtained in transmission on the SMI beamline (12-ID) at NSLS II, a microbeam with an energy of 16.1 keV and a beam size of 2 μm×25 μm.

2N/DIO—Typical SAXS and WAXS images obtained on cooling the 50:50% 2N/DIO mixture from the NF to the SmA_{F} phase are shown in FIG. 2(A). In the NF phase at T= 57.9° C., we observe a nematic-like, diffuse scattering arc peaked in azimuthal orientation with scattering vector q along n, coming from the head-to-tail pair correlation of the molecules along n. Line scans of the scattering intensity through these peaks are shown in FIG. 2(B). As seen in the inset of FIG. 2(B), the SmA_{F} phase is heralded by the appearance of a new, resolution-limited peak along q_{z}, first showing up at T≈56° C., at q_{zAF}, 0.267 Å⁻¹, a wavevector very close to the diffuse nematic peak at q_{z}≈0.271 Å⁻¹. This behavior indicates a first-order phase transition from the N_{F} to the SmA_{F}, in accordance with our polarized light microscope observations. The corresponding layer spacing is d_{AF}=23.5 Å, comparable to the concentration-weighted average molecular length of DIO (23.2 Å) and 2N (23.4 Å). The absence in the SAXS images of half-order peaks at q_{z}=q_{zAF}/2 indicates that there is no observed tendency for bilayer fluctuations or ordering in the SmA_{F} in this mixture. The WAXS diffraction image in FIG. 2(A) shows the second-harmonic scattering from the layers at 2q_{zAF}≈0.53 Å⁻¹. The full width at half-maximum azimuthal mosaic distribution of n in the magnetically aligned sample is initially ~5°. The scattering pattern rotates in the SmA_{F} phase on cooling due to dynamical textural rearrangements in the capillary and at lower temperature there is some detectable scattering from the layering at all azimuthal angles as the magnetic torque is not strong enough to maintain the alignment of the increasingly rigid smectic layers.

7N/DIO—Typical SAXS diffraction images obtained on cooling the 50:50% 7N/DIO mixture from the SmZ_{A} to the SmA_{F} phase are shown in FIGS. 3(A) and 4. The SmA_{F} scattering is qualitatively similar to that of the 2N/DIO mixture. In the SmZ_{A} phase at T=43.6° C., the SAXS shows a diffuse, nematic-like scattering arc, peaked with scattering vector q along n, coming from head-to-tail pair correlations of the molecules along n∥z. Radial line scans of the scattering intensity along n (the white lines depicted in FIG. 3(A)) are shown in FIG. 3(B).

As in the 2N/DIO mixture, the SmA_{F} phase is characterized by a new, resolution-limited peak along q_{z}, first appearing at T≈31° C., at q_{zAF}≈0.245 Å⁻¹, at the maximum of the diffuse nematic peak, as shown in the inset of FIG. 3(B). The corresponding layer spacing d_{AF}=25.6 Å is comparable to the concentration-weighted average molecular length of DIO (23.2 Å) and 7N (29.1 Å). The absence in the SAXS images of half-order peaks at q_{z}=q_{zAF}/2 again indicates that there is no tendency to form bilayers. As in the DIO/2N mixture, the scattering pattern rotates in the SmA_{F} phase due to dynamical textural rearrangements in the capillary with changing temperature. The scattering arc becomes wider in the SmA_{F} as the effectiveness of the magnetic field alignment is reduced on cooling.

Finally, the equatorial Bragg spots at q_{y}=q_{y}m coming from the density modulation due to the smectic layering of the SmZ_{A}, which are observed in both the 2N/DIO and 7N/DIO mixtures but are not visible in FIG. 2(A) or 3(A) because they are relatively weak, are shown in FIG. 4.

Polarized optical transmission microscopy enables direct visualization of the director field, n(r), and, apart from its sign, of P(r). These observations provide key evidence for the macroscopic ferroelectric ordering, uniaxial optical textures, and fluid layer structure of the SmA_{F} phase of the 2N/DIO and 7N/DIO mixtures.

7N/DIO—The 50:50% 7N/DIO mixture was studied in a d=3.5 μm cell with anti-parallel surface rubbing (an antipolar cell) with planar electrodes on one surface separated by a 1 mm gap. In the N phase, the LC formed a uniformly aligned monodomain with n along the buffing direction, as previously observed in the N phase of DIO. In the 7N/DIO mixture with no field applied there is little change in sample appearance with temperature of these cells, the nematic texture being maintained upon cooling into the SmZ_{A} and SmA_{F} phases, as seen in FIG. 3(C1,2). At the SmZ_{A} to SmA_{F} transition, the SmZ_{A} layers parallel to n disappear while new SmA_{F} layers, normal to n, form. The birefringence color is uniform everywhere in the cell and changes only slightly during the N→SmZ_{A}→SmA_{F} cooling sequence, providing evidence that the phase is uniaxial or only weakly biaxial and that the optical anisotropy is nearly the same in all three phases. The uniaxiality of the N phase and the weak biaxiality of the SmZ_{A} have been demonstrated previously.

The SmZ_{A} layers adopt bookshelf geometry, with the smectic layers normal to the plates and with Rapini-Papoular type anchoring of the molecules aligning the director along the rubbing direction. The transition of the antiferroelectric SmZ_{A}, with its layer-by-layer alternation of P, to the ferroelectric SmA_{F} phase is achieved by a coarsening process in which layers with the same sign of P coalesce into broader stripes of uniform polarization extended along z, leading to a texture of irregular, needle-like ferroelectric domains of alternating polarization in the SmA_{F}. While this process produces only subtle changes in the textures in the absence of applied field (compare FIG. 3 (C1 and 2)), application of an in-plane electric field normal to n induces rotation of P in opposite directions in domains with opposite polarization, facilitating and inducing the coarsening of the domain pattern (FIG. 3 (C3 to 6)). This electric field response becomes increasingly dramatic as the stripes coarsen from the nanoscale to the microscale.

After extended application of weak electric fields, the SmA_{F} cell anneals, in the absence of further applied field, into long, rectangular bookshelf domains with uniform birefringence and excellent extinction, typical of weakly oriented smectic A textures, as shown in FIG. 3 (D1,2). Sufficiently large transverse DC fields can completely reorient the SmA_{F} layers so that P and n become aligned along E, normal to the buffing direction (FIG. 3 (D5)). In the N_{F} phase, this kind of global, field-induced reorientation is essentially thresholdless, reversing readily on applied field reversal, but in the SmA_{F} phase there is a distinct threshold for switching and hysteresis in the response, manifest in the polarization data of FIG. 5. This behavior can be understood by considering that field-induced reorientation of a spatially uniform SmA_{F} can only be accommodated by the generation of a population of gliding edge-dislocations, an inherently non-linear process. The effect of this threshold is immediately apparent in the electro-optic behavior in cells with in-plane electrodes. In an applied field, these domains reorient, buckle, and, in sufficiently large applied field, coarsen to form large domains with the n, z, and P all oriented along the field, normal to the buffing direction FIG. 3 (D3 to 5). Thus, it appears that, during field-induced reorientation, in, z, and P remain coupled together, with the threshold originating from the elasticity and plasticity of the smectic layering. This threshold also results in the appearance of a coercive field in the polarization hysteresis (FIG. 6). The N_{F} typically responds readily to in-plane applied electric fields present anywhere in the cell, including above metal or ITO electrodes, and even to small fringing fields far from any electrodes. In the SmA_{F} phase, in contrast, this response becomes sub-threshold and is eliminated from these peripheral areas, with electro-optic effects confined to the designated active areas of the cell where the field is strongest, as seen in FIGS. D3 to D5.

An interesting side observation is the lack of field response in the regions to the left and right sides of the air bubbles in FIG. 3 (C3 to 6). This “shadowing” effect is a direct consequence of the ferroelectric nature of SmA_{F} phase. The air bubble in the middle of the gap between the electrodes into a series connection of impedances: the left/right electrode and right/left boundary of the bubble with SmA_{F} as filling medium and the air bubble with air as the filling medium. The regions with SmA_{F} as a medium have low electrical impedance due to reorientation of the large polarization density, while the air bubble capacitance will be small, dropping most of the applied voltage, and leaving little field response in the adjacent LC.

2N/DIO—The 50:50% 2N/DIO mixture was studied in an antipolar d=3.5 μm cell (with anti-parallel surface rubbing), and in a synpolar d=5 μm cell (with parallel surface buffing).

In the antipolar cell, the surface anchoring imposes a twist structure in the N_{F} phase in which the director/polarization field n(r),P(r) rotates by n through the thickness of the cell. FIG. 2(C) shows the cell being cooled through the first-order N_{F} to SmA_{F} transition. The twisted N_{F} state (seen as broad, diffuse domains in the lower part of these images) has a somewhat rough texture, with SmA_{F} domains with uniform birefringence growing as smooth dark and bright bands or rectangular blocks in the upper part of the field of view. The uniformity of the birefringence color, and the observation that the SmA_{F} domains can be rotated to extinction between crossed polarizers, indicate that the director twist has been expelled and the principal optic axis along n is locally uniform through the cell in the SmA_{F} regions, with n(r) uniformly parallel to the plates. The growing SmA_{F} domains are not strongly orientationally aligned by the cell surfaces initially, most likely because of the ambivalence of these now polar domains towards the antipolar surfaces. The results of application of a weak probe electric field normal to the director are shown in FIG. 5 (A-C), confirming that each domain is internally homogeneously polar (black/white arrows) with orientation along the local director, some pointing up and some pointing down. The expulsion of bend and twist of n(r) by the smectic A_{F} layering, and expulsion of splay of n(r) in order to eliminate polarization charge, results in steady-state textures of uniformly oriented SmA_{F} blocks, as shown in FIG. 2(D), in which there are distinct domain boundaries running either parallel or perpendicular to n. The boundaries parallel to n (approximately vertical in these images) are polarization-reversal walls like those found in the N_{F} phase, while those perpendicular to n are either melted grain boundaries of the type commonly found in SmA phases not completely aligned by weak buffing, or are polarization-stabilized kinks (PSKs), as sketched in the inset of FIG. 2(E). Changes in the sign of P(r) across the horizontal boundaries would generate maximal space-charge and are thus avoided, with jumps in the orientation of P(r) at these locations being limited to 100 or less. In general, there is a tendency to form long SmA_{F} domains of uniform polarization extended along the director, as seen in FIGS. 2(D) and 3(D). The internal variation of orientation within the blocks is generally a few degrees, and tends to bend in the director, which must be mediated by edge dislocations in the SmA_{F} layering system.

More detailed structures of the transition regime that mediates the growth of the uniform SmA_{F} domains into the twisted region are shown in FIG. 5 (D-F). Here, remnant diamond-shaped N_{F} twist domains connect to surrounding uniform SmA_{F} domains by forming PSK domain boundaries with the polarization directions in the sample midplane indicated in FIG. 5(E). Similar structures constitute the zig-zag SmA_{F}-N_{F} boundary line.

If the SmA_{F} is heated back into the N_{F} phase, the removal of the layering constraints enables the polarization-reversal walls to restructure into nematic splay-bend walls extended along the director, separated by areas of uniform polarization (as seen in FIGS. 2 (D2), 3). The horizontal melted grain boundaries disappear in the absence of layering, while the horizontal PSK lines can persist into the N_{F} but then also melt away, leaving only the splay-bend walls (bright lines in FIGS. 2 (D2), 3). Because of the antiparallel boundary conditions, the initially uniform N_{F} states are only metastable and the inherently twisted cores of the splay-bend walls act as nucleation sites for the formation of lower-energy, twisted domains, which eventually spread to cover the entire area (FIG. 2 (D5)).

In the synpolar cell, the surface treatment stabilizes monodomains in which n is homogeneously aligned along the buffing direction. The texture and birefringence of these monodomains barely change on cooling through the N-SmZ_{A}-N_{F}-SmA_{F} phases, exhibiting excellent extinction between crossed polarizers in the NF and SmA_{F} phases except near air bubbles, as seen in FIG. 2 (E). The first image shows how the uniform background NF director field favored by the cell surfaces is distorted to accommodate the non-uniform n(r) orientation imposed by the boundary conditions at the bubble boundaries, where the n(r) field is tangential, a configuration which requires only bend of the director and minimizes the amount of space-charge deposited at the LC/air interface. On the sides of the bubble, the director field distortion relaxes continuously with distance, with the director field eventually becoming indistinguishable from the surrounding uniform state. AL the top and bottom of the bubble, however, the 90° angular mismatch of the circumferential P(r) and the uniform background is accommodated by a “fracture” of P(r) in the form of a polarization-stabilized kink, sketched in the inset. The PSK has a minimum-energy discontinuity in P(r), with an internal structure determined by the balance of Frank elastic and electrostatic interactions, the latter manifested as an attraction between sheets of polarization charge of opposite sign (shown immediately above and below the wall in the inset), which stabilizes the wall. The kink orientation locally bisects the angle between the incoming and outgoing P(r) directions, leading to a globally parabolic boundary between the regions with uniform and circular bent-director fields having minimal bulk polarization charge. Such 2D parabolic textures are readily observed in NF cells in which P(r) is parallel to the bounding plates, its typically preferred orientation.

At the N_{F}-SmA_{F} transition, the areas of uniform director orientation expand, a result of the appearance of the SmA layering. In the absence of edge and screw dislocations, smectics expel both bend and twist of n(r), allowing, in inhomogeneously aligned non-polar smectics A, layering defects only in the form of focal conic domains, as these require only splay of n(r). However, in the polar SmA_{F} phase, splay is also suppressed because of the associated polarization charge, leading to a strong tendency to form domains of uniform n(r). As the smectic layers form on cooling, the bent-director region near the bubble, in which there is both bend and twist of n(r), is therefore reduced in size, as shown in the second image of FIG. 2 (E). The remaining bent- and twisted-director region near the bubble must be accommodated by edge and screw dislocations in the smectic A layering.

Polarization dynamics and field-induced phase transitions—The polarization was measured in a d=17 μm ITO-sandwich cell with bookshelf layering using a low-frequency (8 Hz), 30 V peak amplitude triangle wave. The electrical response of the 2N/DIO mixture is summarized in FIG. 6. At the beginning of the current voltage cycle shown in FIG. 6 (A), the applied voltage is large and negative (V(t)≈−30 V), at which time any ions have been pulled to the cell surfaces. In the N phase (T>84° C.), the current shows a bump following the sign change of V(t), which we attribute to ions This current is subtracted out when calculating P. In the SmZ_{A} phase (84° C.>T>68° C.), LC repolarization peaks appear when the voltage is decreasing, growing in area, with their peak center voltages V_{FA} becoming smaller on cooling, behavior very similar to that of neat DIO. This is typical antiferroelectric behavior, the peaks marking the return at finite voltage of the field-induced ferroelectric state to the antiferroelectric ground state. In the SmZ_{A} the polarization current interacts with ion current in a complex way following each sign change of V(t), so P(T) is obtained by doubling the I(t) area left of the t=0 axis (before the zero-crossing of the applied voltage), where there is no ion current. In the N_{F} phase, the Goldstone-mode mediated reorientation and reversal of P produces the current peak at the zero crossing of V(t), followed by an ion peak for t>0. P(T), taken as the area of the big peak, is found to be comparable to that of neat DIO. In the SmA_{F} phase, the ion current disappears altogether and polarization reversal occurs after the zero-crossing, at a finite voltage corresponding to the coercive field E_{c} plotted as solid symbols in FIG. 6 (B) and shown schematically in the adjoining hysteresis loop.

The ferroelectric smectic A phase adds an exciting new dimension to the ferroelectric nematic realm. The ferroelectric nematic, chiral ferroelectric nematic, and antiferroelectric smectic Z_{A} have each opened unanticipated doors to new soft matter science and technology, and here the smectic A_{F} joins in this development. The SmA_{F} is a layered, spontaneously polar fluid, the long-sought-after proper ferroelectric smectic A liquid, its reorientable macroscopic spontaneous polarization now definitively proven. The transitions to the SmA_{F}, either N_{F} to SmA_{F} Or SmZ_{A} to SmA_{F}, are first-order, and rather subtle in cells with parallel polar surface anchoring with their textures and many of their phase properties exhibiting continuity through the transition. The polarization, ~90% saturated in the N_{F}, remains so in the SmA_{F}, in the presence of the long-range side-by-side molecular positioning implied by the smectic A layer ordering. This is something of a conundrum since side-by-side is the highest energy arrangement of similarly oriented dipoles.

### Materials and Methods

The mixtures were studied using standard liquid crystal phase analysis techniques, including polarized transmission optical microscopy observation of LC textures and their response to electric field, x-ray scattering (SAXS and WAXS), and techniques for measuring polarization and determining electro-optic response.

Materials—DIO, shown in FIG. 1, was synthesized for these experiments. Synthesis of AUUQU2N and AUUQU7N in FIG. 1 followed that of AUUQU3N.

X-ray scattering—For SAXS and WAXS, the LC samples were filled into 1 mm-diameter, thin-wall capillaries. The director n was aligned with an external magnetic field normal to the beam. Diffraction data presented here were obtained on the SMI beamline at NSLSII with a photon energy of 16 keV (wavelength=0.775 Å). At this wavelength, the desired range of scattering vectors (q<0.5 Å⁻¹) encompasses a small range of scattering angles (θ<3°), so that the Ewald sphere can be approximated as an Ewald plane, (q_{y},q_{z}), which is normal to the beam, with z along the magnetic field B and director n orientation. SAXS and WAXS images of 2N, 7N, and their mixtures with DIO obtained on cooling from the Iso to the nematic phase, show the intense, diffuse scattering features at q_{z}~0.25 Å⁻¹ and q_{y}~1.4 Å⁻¹ from end-to-end and side-by-side molecular positional pair correlations, respectively, that are characteristic of this type of polar mesogen.

Electro-optics—For making electro-optical measurements, the mixtures were filled into planar-aligned, in-plane switching test cells with unidirectionally buffed alignment layers on both plates. Cells with antiparallel buffing on plates separated by d=3.5 μm, and with parallel buffing on plates with a d=5 μm separation, were used. In-plane ITO electrodes were spaced by 1 mm and the buffing was parallel to this gap. Such surfaces give a quadrupolar alignment of the N and SmZ_{A} directors along the buffing axis and polar alignment of the N_{F} at each plate. Antiparallel buffing stabilizes a twisted configuration in the N_{F} phase, generating a director/polarization field that is parallel to the plates and undergoes a n-twist between the plates. Parallel buffing generates polar monodomains in the N_{F} and SmA_{F} phases.

Polarization measurement—We measured the I(t)-V(t) characteristics of the 50:50 wt % 2N/DIO mixture as a function of temperature for AC electric field applied along in. The current response I(t) to an 8 Hz, 30 V peak amplitude triangle wave V(t) was measured in a d=17 μm ITO-sandwich cell with bookshelf layering during an N→SmZ_{A}→N_{F}→SmA_{F} cooling scan.

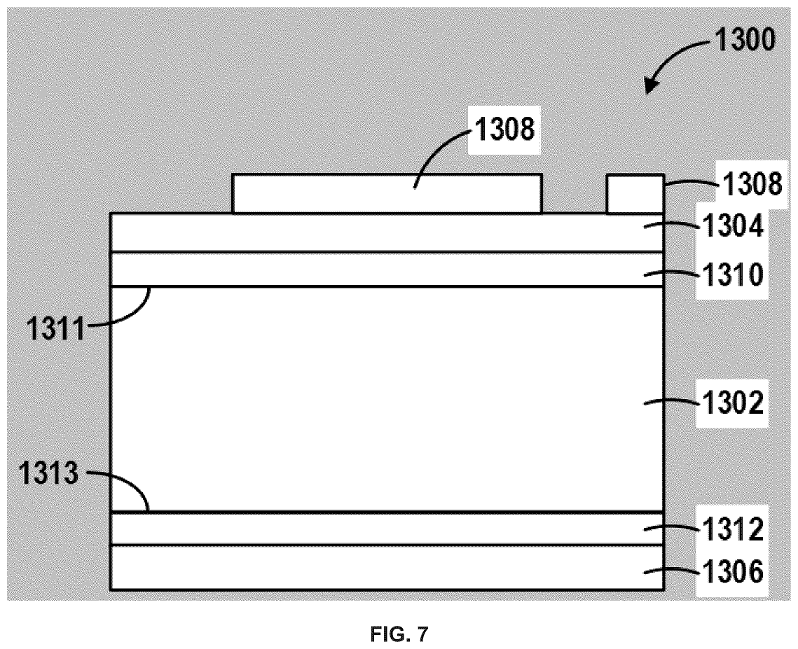

FIG. 7 illustrates a device 1300 in accordance with various examples of the disclosure. Device 1300 includes a volume 1302 comprising ferroelectric smectic A (SmA_{F}) liquid crystal-forming fluid and means (e.g., plates or surfaces 1304, 1306 or the like) for containing said fluid. The plates or surfaces can include, for example, glass, polymers, such as PET, polycarbonate, or the like. In the illustrated example, device 1300 also includes one or more polymer layers 1310, 1312 and/or electrodes. Exemplary polymers for layers 1310, 1312 include polyimide. Surfaces 1311 and/or 1313 can be buffed, using velvet, for example.

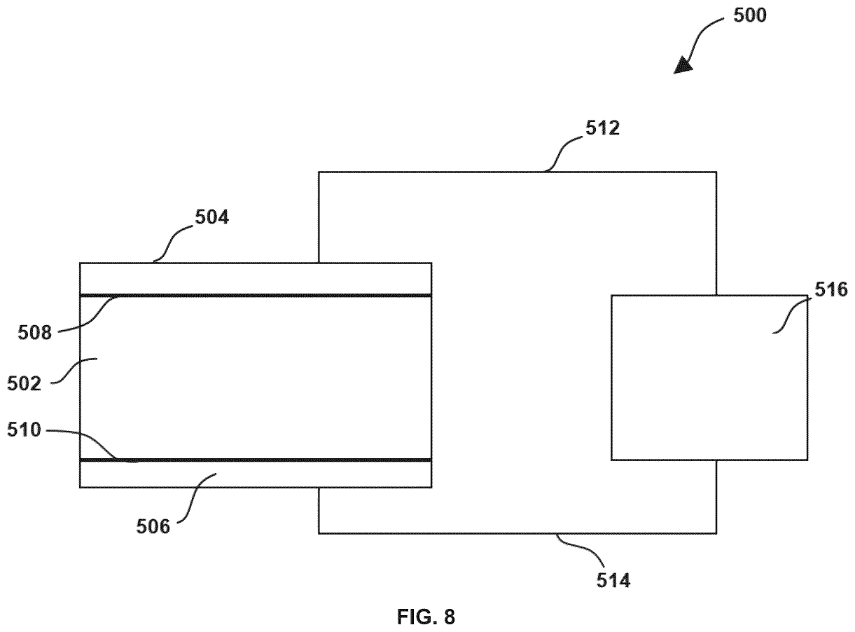

FIG. 8 illustrates another device 500 in accordance with various embodiments and examples of the disclosure. Device 500 includes a volume 502, one or more materials 504, 506 comprising one or more surfaces 508, 510 in contact with volume 502. Device 500 also includes one or more electrical connections 512, 514 that can be coupled to an electrode, such as electrode 1308 or electrodes described below to apply an electric field to the volume and an apparatus 516 to apply an electromagnetic field or electric field to the volume.

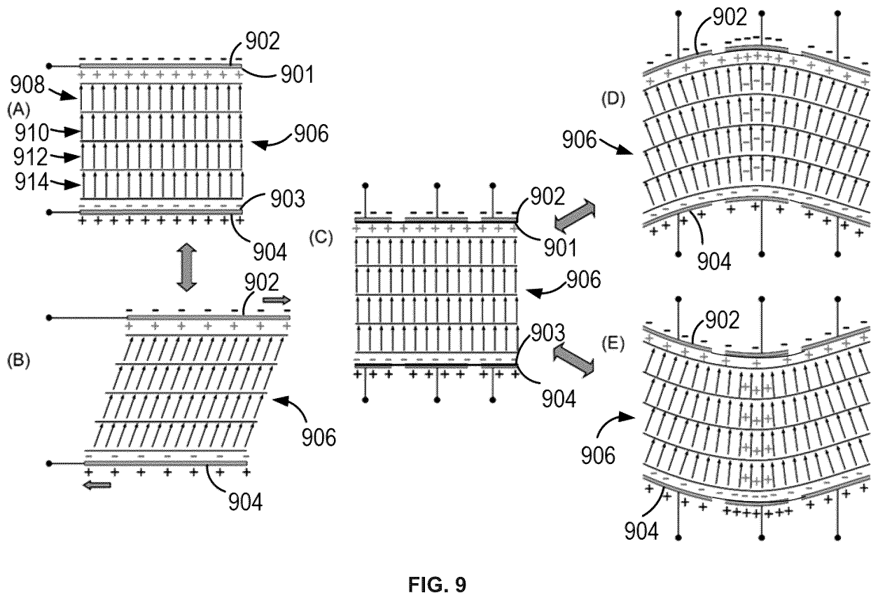

FIG. 9 illustrates cell deformation modes for electro-mechanical energy conversion. The ferroelectric smectic A material 906 is filled between planar electrodes 902, 904 on surface 901, 903 with the smectic layers 908-914 parallel to the surface. (A,B) In-plane shear of the smectic layers generates electrical current. In (A), the polarization is parallel to the layer normal. The polarization charge at the surfaces is balanced by the free charge on the electrodes. (B) Shearing parallel to the electrodes causes reorientation of the polarization, reducing the surface polarization charge density and causing a potential difference between the electrodes. In such a periodically sheared system, a dynamic current could be generated through an external circuit. (C-E) Bending of the smectic layers generates electrical current. In (C), there are three parallel electrodes at each surface. In the absence of mechanical deformation, the smectic layers are strain-free and free charge is homogeneously distributed along the electrodes. Bending of the layers (D,E) results in an accumulation of both bound and free charge in the central, bent region. The free-charge imbalance between neighboring electrodes could be used to generate current through an external circuit.

There are three types of major deformation of the director field of liquid crystals: splay, bend, and twist. In a conventional (non-polar) smectic A material, bend and twist of the director are largely suppressed because these deformations would disturb the preferred uniform layering. Splay of the director is allowed, however, this deformation corresponding to bending of the layers and being achieved largely without affecting the layer spacing.

In the ferroelectric smectic A phase, the presence of a large, macroscopic, ferroelectric polarization P enables new electro-mechanical effects, laying the foundation for novel electro-mechanical devices. Any splay of the polarization P generates polarization space charge ρₚ=−∇·P, with an associated electrostatic energy proportional to polarization squared (Eₚ ∝P²). The electric field generated by the polarization charge increases the bulk electrostatic energy by an amount

$${U}_{p} = \frac{1}{2} k \int dV \frac{∇ \cdot P ( r ) ∇ \cdot P ( {r}^{′} )}{\vert ( r - {r}^{′} ) \vert}$$

where k=(¼π∈) and ∈ is the dielectric permittivity of the liquid crystal. Since the director n and P are colinear, this results in an effective stiffening of the director field's response to splay deformation. Assuming a periodic transverse modulation of the polarization δP_{y}(r) of amplitude Pδn_{y} and wavevector q_{y}, so that ∇·P(r)=∂P_{y}(y)y=iq_{y}P_{z}δn_{y} in our geometry, we have an elastic energy density

$${U}_{s p} = \frac{1}{2} [ {K}_{s} {q}_{y}^{2} + \frac{4 π {P}^{2}}{ϵ} ] {\vert δ {n}_{y} \vert}^{2} = \frac{1}{2} [ {K}_{s} + \frac{4 π {P}^{2}}{ϵ {q}_{y}^{2}} ] {q}_{y}^{2} {\vert δ {n}_{γ} \vert}^{2}$$

where Kₛ is the Frank splay elastic constant of the liquid crystal. This expression has the usual form of a Frank free energy density with an effective splay elastic constant K_{eff}, given by

$${K}_{eff} = {K}_{S} + \frac{4 π {P}^{2}}{ϵ {q}_{y}^{2}}$$

The inverse-square dependence on wave vector of the contribution of the polarization to the effective elastic constant implies that the polarization term will be dominant for q_{y}<2\sqrt{π}/ξₚ, where ξₚ=\sqrt{∈K/P²} is the polarization self-penetration length. Since for P= 6 μC/cm² we have ξₚ~0.1 nm, this dominance will persist down to molecular length scales.

As a result, in the SmA_{F} phase, in addition to the suppression of bend and twist, splay is expelled, resulting in a kind of “soft crystal.” By applying sufficient mechanical stress, however, one can introduce deformations of the director field, with the work done converted to electrostatic energy that can drive electrical current in an external circuit. Two examples of such applications, illustrated in FIG. 9, are as follows.

First, in a cell with parallel-plate capacitor geometry and smectic layers initially oriented parallel to the electrodes, as in FIG. 9 (A), the surface depolarization charge at the cell boundaries would be balanced by the free charge on the electrodes. The liquid-like nature of the smectic layers ensures that the shear viscosity is small when the cell is sheared along a direction parallel to the layers, as in FIG. 9 (B). This shearing action couples to the director field and causes tilting of the polarization, which results in a decrease in the surface depolarization charge. The mismatch between the free charge and the surface depolarization charge introduces a voltage across the electrodes V=Pd(1−cos θ), where d is the cell thickness and θ is the shear-induced tilt angle. This electro-mechanical signal is unique to the SmA_{F} phase, being absent in the conventional SmA, where there is no ferroelectric polarization. The sign of the induced voltage alternates with the shearing direction, a response that can be useful for a dynamic mechanical-to-electrical energy converter.

In a second example, a liquid crystal material is again filled into a cell with parallel-plate capacitor geometry, with the smectic layers parallel to the electrodes. In this case, there are multiple electrodes at each surface, but again the surface depolarization charge is uniformly distributed along the cell boundaries and balanced by free charge on the electrodes, as indicated in FIG. 9 (C). If sufficient stress is applied to bend the layers, as shown in FIG. 9 (D) and (E), polarization space charge appears in the liquid crystal and the density of surface depolarization charge changes near the bounding electrodes, upsetting the balance of free and depolarization charge at the cell surfaces and leading to potential differences between neighboring electrodes (902, 904) on the same surface. The sign of the induced voltages alternates with the bending direction and could again be used for dynamic mechanical-to-electrical energy conversion.

Piezoelectricity is a well-known and studied electro-mechanical effect in solid ferroelectric crystals. In crystalline materials, mechanical deformation is resisted by the rigidity of the lattice: a huge stress is needed to achieve even a small deformation of the material. As a result, most of the work done on the material is stored as elastic energy in the crystal rather than being converted to electrostatic energy by coupling to the polarization. Liquid crystals in the SmA_{F} phase have spontaneous polarizations that in magnitude approach those of solid ferroelectrics and enjoy a fundamental advantage in that they are much less rigid, the effective stress modulus associated with inducing voltages by causing polarization splay being much smaller in the SmA_{F} phase than that associated with generating a comparable piezoelectric response in a solid. This implies that electro-mechanical energy conversion should be much more efficient in SmA_{F} liquid crystals than in crystalline ferroelectrics.

### PARTICULAR EXAMPLES OF THE DISCLOSURE

### A: Examples Related to SmA_{F} Devices

1. A device comprising a volume comprising ferroelectric smectic A (SmA_{F}) liquid crystal-forming fluid and means for containing said fluid, said fluid comprising molecules, said molecules organized into layers, said molecules having one or more electric dipoles, said molecules having spontaneously formed a ferroelectric polarization density, said polarization density comprising a nonzero local unidirectional average orientation of said dipoles, and said polarization density comprising a magnitude and a vectorial direction in said volume, said vectorial direction being locally normal to said layers.
2. The device of example 1 for electrical control of an electromagnetic field, wherein said device includes one or more electrodes for application of an electric field to said volume, and the electromagnetic field propagates in said volume, said electric field causing said polarization density to change in magnitude, thereby producing a change in the electromagnetic field.
3. The device of example 1 for electrical control of an electromagnetic field, wherein said device includes one or more electrodes for application of an electric field to said volume, and an electromagnetic field to be controlled propagates in said volume, said electric field causing said polarization density to change the vectorial direction, thereby producing a change in the electromagnetic field.
4. The device of example 1 for producing electrically-driven motion, wherein said device includes one or more electrodes for application of an electric field to said volume, said electric field causing said polarization density to change in the vectorial direction and/or the magnitude, thereby producing a physical motion of or change of shape of said volume.
5. The device of example 1 for performing mechanical sensing, wherein said device includes one or more electrodes for measuring the electric potential or current flow within said volume, said electric potential and/or current flow generated by change in said polarization density, said change due to a variation in stress within said volume or change of shape of at least a portion of said volume.
6. The device of example 1 for thermally generating a charge density, wherein said device includes one or more electrodes for measuring an electric potential or obtaining a current flow within said volume, said electric potential and/or current flow generated by a change in said polarization density, said change of said polarization density produced by a change in temperature of said volume.
7. The device of any of examples 1-6, wherein said volume is contained between parallel surfaces.
8. The device of example 7, wherein an/said electric field is applied parallel to the surfaces.
9. The device of example 7, wherein the polarization density is parallel to said surfaces.
10. The device of any of examples 7 or 8, wherein said electromagnetic field has a polarization parallel to the surfaces.
11. The device of example 2 or example 3, wherein said electric field, said polarization density, and a polarization component of said electromagnetic field are along the same line.
12. The device of any of examples 2, 3, or 7, wherein the electromagnetic field comprises one or more of microwave, infrared, visible, ultraviolet, and x-ray light, propagating in or reflecting from said device.
13. The device of example 1 for performing molecular dipole scavenging, wherein said polarization density produces local molecular-scale cavities, said cavities binding molecules having dipoles in said volume.
14. The device of any of examples 1-13, wherein said ferroelectric smectic A liquid crystal-forming fluid comprises dimeric, oligomeric, or polymeric material.
15. The device of any of examples 1-13, wherein said ferroelectric smectic A liquid crystal-forming fluid comprises elastomeric material.
16. The device of any of examples 1-13, wherein said ferroelectric smectic A liquid crystal-forming fluid comprises a glass.
17. The device of any of examples 1-16, wherein the molecules comprise features suitable for the stabilization of a ferroelectric smectic A phase comprising one or more of: (1) a rod shape having a molecular long axis suitable for smectic A liquid crystal ordering; (2) a substantial molecular net dipole parallel to the molecular long-axis, said dipole stabilizing head-to-tail chaining of said rod-shaped molecules; (3) molecular subcomponents along the molecular length giving localized charges of alternating sign distributed along said molecular long axis; (4) minimal flexible tails to enable dipolar charges to interact, but provide enough flexibility to suppress crystallization; and (5) lateral groups to control the relative positions along the director of side-by-side molecules, to promote their polar order.
18. A method of using any of the devices of examples 1-17.

### B: Examples Related to Polar Alignment by Substrates

19. A device comprising:
   a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the electric polarization density throughout the volume; and
   one or more materials comprising one or more surfaces in contact with the volume, wherein said one or more surfaces are configured to impart a favored surface polarity of the molecules, said favored surface polarity controlling said vectorial orientation at the interfaces with the one or more surfaces.
20. The device of example 19, wherein the one or more materials comprise a first material comprising a first surface in contact with the volume and a second material comprising a second surface in contact with the volume.
21. The device of example 20, wherein the second surface is configured to impart, at an interface with the second surface, a favored surface polarity of the molecules to control a vectorial orientation of the molecules within the volume.
22. The device of any of examples 19-21, wherein the favored surface polarity of the molecules comprises a component locally normal to and directed away from at least one of the one or more surfaces.
23. The device of any of examples 19-21, wherein the favored surface polarity of the molecules comprises a component locally normal to and directed toward at least one of the one or more surfaces.
24. The device of any of examples 19-21, wherein the favored surface polarity of the molecules comprises a component locally tangent to at least one of the one or more surfaces.
25. The device of example 24, wherein said component comprises a unique favored azimuthal orientation about a surface normal to at least one of the one or more surfaces.
26. The device of any of examples 19-25, wherein the favored surface polarity of the molecules comprises a component created via photo-degradation induced by illumination of one or more of the surfaces.
27. The device of any of examples 19-25, wherein the favored surface polarity of the molecules comprises a component created by deposition of material onto a surface of the one or more surfaces.
28. The device of any of examples 19-25, wherein the favored surface polarity of the molecules comprises a component created by deposition of material onto a surface of the one or more surfaces, where said deposition is oblique.
29. The device of any of examples 19-25, wherein the favored surface polarity of the molecules comprises a component created by etching of material from the one or more materials.
30. The device of any of examples 19-25, wherein the favored surface polarity of the molecules comprises a component created by etching of material from the one or more materials, where said etching is oblique.
31. The device of any of examples 19-30, further comprising:
   one or more electrical connections to apply an electric field to the volume.
32. The device of any of examples 19-31, further comprising:
   an apparatus to apply an electromagnetic field to the volume.
33. A method for controlling a favored vectorial orientation in three dimensions of a polarization field of a SmA_{F} liquid crystal at an interfacial surface with a material or materials, the method comprising:
   providing a volume comprising SmA_{F} liquid crystal-forming molecules;
   providing a first material having a first surface in contact with the volume; and
   using the first surface, imparting a favored surface polarity of the molecules, said favored surface polarity controlling said favored vectorial orientation of the molecules in said volume.
34. The method of example 33, further providing a second material having a second surface in contact with the volume.
35. The method of example 33 or example 34, wherein the favored surface polarity of the molecules comprises a component locally normal to the surface and directed toward the surface.
36. The method of example 33 or example 34, wherein the favored surface polarity of the molecules comprises a component locally normal to the surface and directed away from the surface.
37. The method of example 33 or example 34, wherein the favored surface polarity of the molecules comprises a component locally tangent to the first surface.
38. The method of example 37, wherein said component comprises a unique favored azimuthal orientation about the surface normal.
39. The method of any of examples 33-38, further comprising a step of applying an electric field to said SmA_{F} phase.
40. Devices and methods of any of examples 19-39, further comprising dopant molecules dissolved in the SmA_{F} phase.
41. Devices and methods of example 40, wherein the dopant molecules have dipole moments, said dipole moments being preferentially aligned by the vectorial orientation field of the SmA_{F} phase adjacent to or in the vicinity of said dopant molecules.
42. Devices and methods of any of examples 19-41, wherein said SmA_{F} phase is a mixture of two or more distinct molecular species.
43. Devices and methods of example 42, wherein said SmA_{F} phase is a eutectic mixture.
44. A device comprising:
   a volume comprising SmA_{F} liquid crystal-forming molecules; and
   a first material comprising a first surface in contact with the volume,
   wherein the first surface is configured to impart a favored surface polarity of the molecules to control a vectorial orientation of the molecules within the volume at an interface with the first surface.
45. The device of example 44, wherein the volume comprises a SmA_{F} phase.
46. The device of example 44 or example 45 including any of the limitations of examples 20-28 and 40-43.

### C: Examples Related to Mixtures

47. A material comprising a ferroelectric smectic A (SmA_{F}) material comprising:
   two or more molecular components.
48. The material of example 47, comprising:
   a mixture of first molecules and second molecules.
49. A method of forming a material having a tunable SmA_{F} phase, the method comprising:
   mixing of multiple molecules to form a mixture having a SmA_{F} phase, wherein certain of the molecules induce a polar orientational order of one or more of the other molecules.

### D: Examples Related to Charge-Controlled Devices

50. A device comprising:
   a volume containing a ferroelectric smectic A (SmA_{F}) liquid crystalline material;
   a dielectric layer overlying a portion of the volume; and
   a charge-bearing substrate overlying at least a portion of the dielectric layer,
   wherein the volume comprises a polarization charge proximate the dielectric layer that is controllable by a charge on and/or applied to the charge-bearing substrate.
51. The device of example 50, further comprising one or more additional dielectric layers overlying the volume.
52. The device of example 51, further comprising one or more additional charge-bearing substrates overlying the one or more additional dielectric layers.
53. The device of any of examples 50-52, wherein each surface bounding said SmA_{F} liquid crystal comprises a dielectric layer adjacent to the liquid crystal and a proximate charge-bearing substrate, each surface having finite capacitance and hence acting as a capacitor.
54. The device of any of examples 50-53, wherein the polarization charge and molecular orientation of the SmA_{F} liquid crystal on the inner (liquid crystal) side of the capacitor is controlled by varying the charge on the outer (substrate) side of the capacitor.
55. The device of any of examples 50-54, wherein the charge on the bounding surface and the resulting molecular orientation of the SmA_{F} liquid crystal responds to external fields or other stimuli, including external electromagnetic or optical fields, chemical or electrochemical reactions, biomolecular binding events, mechanical strain or shear, and fluid flow.
56. The device according to example 55, wherein a response to external fields or other stimuli is detected electrically.
57. The device according to example 55, wherein a response to external fields or other stimuli is detected optically.
58. A sensor comprising a device as in any of examples 50-57.
59. An actuator comprising a device as in any of examples 50-57.
60. An energy conversion device comprising a device as in any of examples 50-57.
61. The device of any of examples 50-57, wherein the volume comprising a SmA_{F} liquid crystal is at least partially bounded by surfaces with spatially varying capacitance, in which said molecular orientation in said SmA_{F} material exhibits spatially varying analog response to applied voltages.
62. The device of any of examples 50-57, wherein the volume comprising a SmA_{F} liquid crystal is at least partially bounded by surfaces with spatially varying capacitance and with patterned electrodes on the bounding substrates, in which said molecular orientation in said ferroelectric nematic material exhibits spatially varying analog response to voltages applied to said patterned electrodes.

### E: Examples Related to Composite Materials

63. A composite material comprising a first porous material, the volume of said pores of said material containing ferroelectric smectic A (SmA_{F}) liquid crystal.
64. The composite material as in example 63 in which the said volume of said pores of said porous material is substantially filled with SmA_{F} liquid crystal.
65. A semiconducting structure comprising a porous, solid material, the volume of said pores of said material containing SmA_{F} liquid crystal.
66. A dielectric structure comprising a porous, solid, electrically insulating material, the volume of said pores of said material containing SmA_{F} liquid crystal.
67. A capacitor comprising electrodes and a dielectric medium, said dielectric medium comprising a porous, solid, electrically insulating material, the volume of said pores of said material containing SmA_{F} liquid crystal.
68. A dielectric medium comprising a SmA_{F} liquid crystal and a solid material, said solid material dispersed in the liquid crystal as particulates.
69. A dielectric medium comprising a SmA_{F} liquid crystal and a solid material, said solid material comprised of ferroelectric or superparaelectric nanoparticles.
70. A dielectric medium comprising a dispersion of a SmA_{F} liquid crystal and a solid material, said dispersion formed by phase separation.
71. A dielectric medium comprising a dispersion of a SmA_{F} liquid crystal and a solid material, said dispersion formed by photo-polymerization.
72. A dielectric medium comprising a dispersion of a SmA_{F} liquid crystal and a solid material, said dispersion stabilized by amphiphilic molecular components.
73. A dielectric medium comprising an emulsion of a SmA_{F} liquid crystal and a fluid material, said emulsion stabilized by amphiphilic molecular components.
74. A device comprising the composite material or dielectric medium of any of examples 63, 64 and 66-73.
75. The device of example 74, wherein the device is an energy storage device.
76. The device of example 74, wherein the device is an energy conversion device.
77. The device of example 74, wherein the device is an information storage and processing device.
78. The device of example 74, wherein the device is an actuator, sensor, electro-caloric device, or a device for electric to mechanical energy conversion through electromechanical effects.

### F: Other Examples

79. A device comprising:
   a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the dipolar SmA_{F} liquid crystal-forming molecules throughout the volume, said dipolar molecules possessing a finite first hyperpolarizability β; and
   one or more electrical connections to apply an electric field to the SmA_{F} liquid crystal-forming molecules.
80. A device comprising:
   a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the dipolar SmA_{F} liquid crystal-forming molecules throughout the volume, said dipolar molecules possessing a finite first hyperpolarizability β; and
   one or more materials comprising one or more surfaces in contact with the volume,
   wherein said one or more surfaces are configured to impart a favored surface polarity of the SmA_{F} liquid crystal-forming molecules, said favored surface polarity controlling said vectorial orientation at the interfaces with the one or more surfaces.
81. A device comprising:
   a volume comprising ferroelectric smectic A (SmA_{F}) liquid crystal-forming molecules, said volume containing a SmA_{F} liquid crystal phase, said SmA_{F} liquid crystal phase comprising a vectorial orientation field of the dipolar SmA_{F} liquid crystal-forming molecules throughout the volume, said dipolar molecules possessing a finite first hyperpolarizability β;
   one or more electrical connections to apply an electric field to the SmA_{F} liquid crystal-forming molecules; and
   one or more materials comprising one or more surfaces in contact with the volume,
   wherein said one or more surfaces are configured to impart a favored surface polarity of the SmA_{F} liquid crystal-forming molecules, said favored surface polarity controlling said vectorial orientation at the interfaces with the one or more surfaces.
82. The device of any of examples 79-81, wherein the device is used for electronic electro-optic phase, amplitude, or polarization modulation of electromagnetic fields.
83. The device of any of examples 79-81, wherein the device is used for nonlinear optical frequency mixing of electromagnetic fields, including second harmonic generation and sum and difference frequency generation.
84. The device of any of examples 79-81, wherein the device is used for nonlinear optical terahertz (THz) electromagnetic field generation and/or sensing.
85. The device of any of examples 79-81, wherein the device is used for nonlinear optical frequency conversion.
86. The device of any of examples 79-81, wherein the device is a component of a photonic integrated circuit.
87. Materials comprising fibers of SmA_{F} liquid crystal.
88. Materials comprising thin films of SmA_{F} liquid crystal.
89. The materials of any of examples 87 or 88, said materials incorporated into composite materials comprising polymeric, amphiphilic, and/or solid components.
90. The materials of any of examples 87-89, said materials comprising functional textiles or fabrics.
91. A device based on the materials of any of examples 87-90, wherein the device is a sensor, actuator, and/or energy conversion device.
92. A device based on the materials of any of examples 87-89, wherein the device is an electro-optic device.
93. Materials comprising a SmA_{F} liquid crystal comprising dipolar molecules with large first hyperpolarizability β, wherein said dipolar molecules have polar orientational order, said polar orientational order controlling the second-order nonlinear optical properties of said materials.

The example embodiments of the disclosure described above do not limit the scope of the invention, since these embodiments are merely examples of the embodiments of the invention. Any equivalent embodiments are intended to be within the scope of this invention. Indeed, various modifications of the disclosure, in addition to the embodiments shown and described herein, such as alternative useful combinations of the elements described, may become apparent to those skilled in the art from the description. Such modifications and embodiments are also intended to fall within the scope of the appended claims.

1. A device comprising a volume comprising ferroelectric smectic A (SmAF) liquid crystal-forming fluid and means for containing said fluid, said fluid comprising molecules, said molecules organized into layers, said molecules having one or more electric dipoles, said molecules having spontaneously formed a ferroelectric polarization density, said polarization density comprising a nonzero local unidirectional average orientation of said dipoles, and said polarization density comprising a magnitude and a vectorial direction in said volume, said vectorial direction being locally normal to said layers.

2. The device of claim 1 for electrical control of an electromagnetic field, wherein said device includes one or more electrodes for application of an electric field to said volume, and the electromagnetic field propagates in said volume, said electric field causing said polarization density to change in magnitude, thereby producing a change in the electromagnetic field.

3. The device of claim 1 for electrical control of an electromagnetic field, wherein said device includes one or more electrodes for application of an electric field to said volume, and an electromagnetic field to be controlled propagates in said volume, said electric field causing said polarization density to change the vectorial direction, thereby producing a change in the electromagnetic field.

4. The device of claim 1 for producing electrically-driven motion, wherein said device includes one or more electrodes for application of an electric field to said volume, said electric field causing said polarization density to change in the vectorial direction and/or the magnitude, thereby producing a physical motion of or change of shape of said volume.

5. The device of claim 1 for performing mechanical sensing, wherein said device includes one or more electrodes for measuring electric potential or current flow within said volume, said electric potential and/or current flow generated by change in said polarization density, said change due to a variation in stress within said volume or change of shape of at least a portion of said volume.

6. The device of claim 1 for thermally generating a charge density, wherein said device includes one or more electrodes for measuring an electric potential or obtaining a current flow within said volume, said electric potential and/or current flow generated by a change in said polarization density, said change of said polarization density produced by a change in temperature of said volume.

7. The device of claim 2, wherein said volume is contained between parallel surfaces and the electric field is applied parallel to the surfaces.

8. The device of claim 3, wherein said volume is contained between parallel surfaces and the electric field is applied parallel to the surfaces.

9. The device of claim 7, wherein the polarization density is parallel to said surfaces.

10. The device of claim 7, wherein said electromagnetic field has a polarization parallel to the surfaces.

11. The device of claim 2, wherein said electric field, said polarization density, and a polarization component of said electromagnetic field are along a same line.

12. The device of claim 2, wherein the electromagnetic field comprises one or more of microwave, infrared, visible, ultraviolet, and x-ray light, propagating in or reflecting from said device.

13. The device of claim 1 for performing molecular dipole scavenging, wherein said polarization density produces local molecular-scale cavities, said cavities binding molecules having dipoles in said volume.

14. The device of claim 1, wherein said ferroelectric smectic A liquid crystal-forming fluid comprises dimeric, oligomeric, or polymeric material.

15. The device of claim 1, wherein said ferroelectric smectic A liquid crystal-forming fluid comprises elastomeric material.

16. The device of claim 1, wherein said ferroelectric smectic A liquid crystal-forming fluid comprises a glass.

17. The device of claim 1, wherein the molecules comprise features suitable for stabilization of a ferroelectric smectic A phase comprising one or more of: (1) a rod shape having a molecular long axis suitable for smectic A liquid crystal ordering; (2) a substantial molecular net dipole parallel to the molecular long axis, said dipole stabilizing head-to-tail chaining of said rod-shaped molecules; (3) molecular subcomponents along the molecular length giving localized charges of alternating sign distributed along said molecular long axis; (4) minimal flexible tails to enable dipolar charges to interact, but provide enough flexibility to suppress crystallization; and (5) lateral groups to control relative positions along the director of side-by-side molecules, to promote their polar order.

18. (canceled)

19. A device comprising: a volume comprising ferroelectric smectic A (SmAF) liquid crystal-forming molecules, said volume containing a SmAF liquid crystal phase, said SmAF liquid crystal phase comprising a vectorial orientation field of the electric polarization density throughout the volume; and one or more materials comprising one or more surfaces in contact with the volume, wherein said one or more surfaces are configured to impart a favored surface polarity of the molecules, said favored surface polarity controlling said vectorial orientation at interfaces with the one or more surfaces.

20. The device of claim 19, wherein the one or more materials comprise a first material comprising a first surface in contact with the volume and a second material comprising a second surface in contact with the volume.
